(19) United States
(12) Patent Application Publication
(10) Pub. No.: US 2009/0323783 A1
(43) Pub. Date: Dec. 31, 2009

(54) CALIBRATION TECHNIQUES FOR MIMO WIRELESS COMMUNICATION SYSTEMS

(75) Inventors: Nicholas E. Buris, Deer Park, IL (US); Bruce D. Mueller, Palatine, IL (US); Frederick W. Vook, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/145,756

(22) Filed: Jun. 25, 2008

(51) Int. Cl. H04B 1/38; H04L 27/28

(52) U.S. Cl. 375/219; 375/260

(57) ABSTRACT

A method, apparatus and system for performing over-the-air calibration routines in a multiple-input multiple-output (MIMO) communication system. An antenna array of a transceiver (e.g., transceiver of a base station) comprises a re-configurable antenna having two switchable configuration states. The antenna exhibits different degrees of electromagnetic coupling to other antennas of the array in a first state than in a second state. The reference antenna is switched to the first state for performing uplink/downlink calibrating transmissions and switched to the second state during uplink and downlink communications or channel sounding calibrating transmissions.

### BACKGROUND

1. Technical Field

The present invention generally relates to wireless multiple-input multiple-output (MIMO) communication systems, and in particular to calibration techniques performed in MIMO communication systems.

2. Description of the Related Art

In general, wireless multiple-input multiple-output (MIMO) communication systems can offer larger channel transmission capacity and reliability than traditional single-input single-output (SISO) systems. A MIMO system employs multiple transmit/receive antennas and transmits data in parallel via an air MIMO channel comprising a plurality of individual spatial channels formed between transmitting and receiving parties, such as base stations and user terminals of the MIMO system.

In operation, transmission characteristics, or responses, of the MIMO channels are often monitored. For example, a base station may need to know a response of uplink/downlink MIMO channels in order to optimize parameters of spatial processing routines performed at the base station during data transmissions to/from user terminals.

Typically, monitoring of the MIMO channel transmission characteristics involves using over-the-air calibrating transmissions to/from a dedicated calibration antenna port in an antenna array of a base station. However, in the antenna arrays of the MIMO communication systems, component antennas are designed to exhibit maximum electromagnetic isolation from each other. Therefore, such calibration techniques require excessive amounts of radio-frequency power (RF) to be generated and transmitted in a MIMO system for monitoring characteristics of the MIMO channels, which decreases effectiveness of the MIMO system.

### SUMMARY OF ILLUSTRATIVE EMBODIMENTS

A method, apparatus and system for performing over-the-air calibration routines in a multiple-input multiple-output (MIMO) communication system are disclosed.

In embodiments of the present invention, an antenna array of a transceiver in the MIMO system (e.g., transceiver of a base station) comprises a re-configurable antenna. In a first state, CAL state, the antenna exhibits a first value of electromagnetic coupling to other antennas of the array, and in a second state, NoCAL state, the antenna exhibits a second value of the electromagnetic coupling to these antennas, which is different than the first value. In operation, the reference antenna is switched to the first state during uplink/downlink calibrating transmissions and switched to the second state during one of (i) uplink and downlink communications and (ii) channel sounding calibrating transmissions.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a high-level functional diagram of an exemplary wireless multiple-input multiple-output (MIMO) communication system configured for implementing one or more embodiments of the invention;

FIG. 2 is a high-level block diagram of a base station and a user terminal of a wireless MIMO communication system in which the features of the invention are implemented, according to one embodiment of the invention;

FIG. 3 illustrates a flow chart of a process by which the features of the invention are implemented, according to one embodiment of the invention;

FIG. 4 is a functional block diagram illustrating calibration transmissions performed by a base station of a wireless MIMO communication system in which the features of the invention are implemented, according to one embodiment of the invention; and

FIG. 5 is a functional block diagram illustrating channel sounding transmissions performed by a user terminal of a wireless MIMO communication system in which the features of the invention are implemented, according to one embodiment of the invention.

### DETAILED DESCRIPTION OF AN ILLUSTRATIVE EMBODIMENT

The illustrative embodiments provide a method, apparatus, system, and computer program product for performing over-the-air calibration routines in a wireless multiple-input multiple-output (MIMO) communication system.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present invention. The following detailed description is, therefore, not to be taken in a limiting sense, and the scope of the present invention is defined only by the appended claims.

Within the descriptions of the figures, similar elements are provided similar names and reference numerals as those of the previous figure(s), except that suffixes may be added, when appropriate, to differentiate such elements. The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. Specifically, as utilized herein, the term “wireless MIMO communication system” broadly refers to wireless communication system at least in part employing multiple antennas at either a base station or a user terminal or at both a base station and a user terminal.

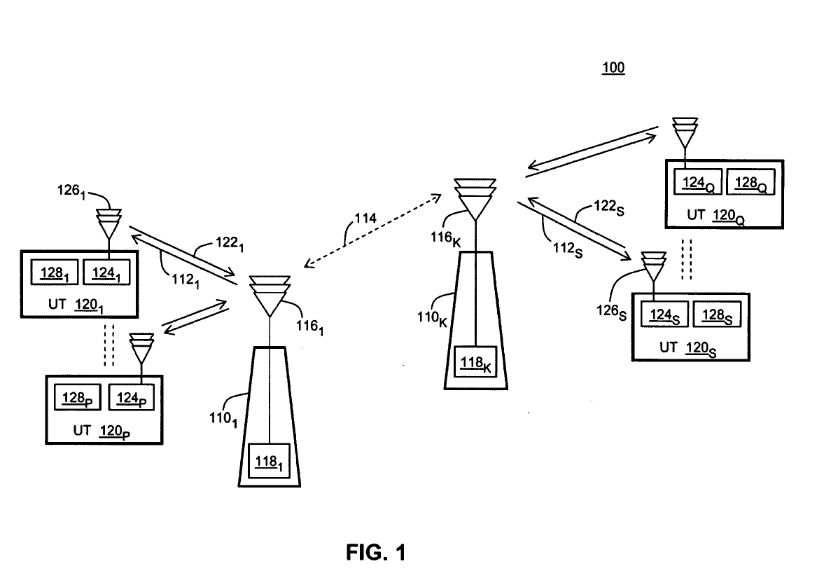

With reference now to the figures, FIG. 1 depicts a high-level functional diagram of exemplary wireless MIMO communication system 100 including a plurality of K base stations 110 and a plurality of Q user terminals (UT) 120 (illustratively, base stations 110₁, 100_{K} and user terminals 120₁-120_{P} and 120_{S}-120_{Q} are shown). The base stations 110 are communicatively selectively coupled to one another via interfaces 114 (for example, wireless (as shown), wired, or optical interfaces), and the user terminals 120 are selectively coupled to regional base stations 110 via wireless downlink interfaces 112 and uplink interfaces 122 (downlink interfaces 112₁, 112_{S} and uplink interfaces 122₁, 122_{S} are shown). In one embodiment, uplink and downlink communications 112, 122 between the base stations 110 and user terminals 120 in the system 100 are performed in compliance with one or more time-division duplex (TDD) transmission protocols.

In exemplary applications, user terminals 120 may be wireless communication devices such as cellular phones, personal digital assistants (PDAs), mobile computers, and the like. In some embodiments, a portion of the base stations 110 may have limited communicating or networking resources and operate as access stations (or access points) for a particular group of the user terminals 120. Herein, in the context of the present invention, the base and access stations are collectively referred to as the “base stations”.

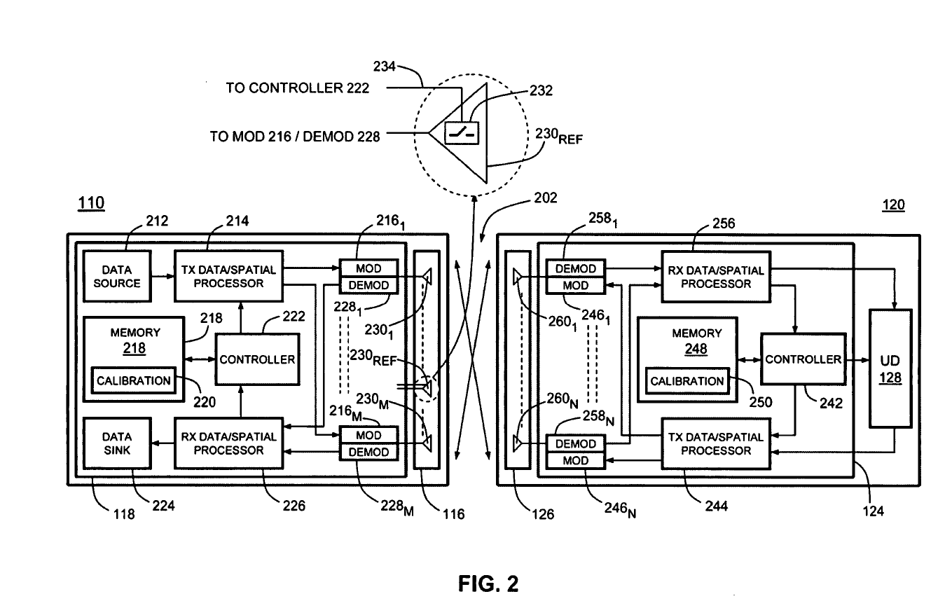

The base station 110 generally includes transceiver 118 and antenna array 116. Antenna array 116 comprises M individuals antennas 230 (shown in FIG. 2), which are selectively coupled to branches of transceiver 118. Correspondingly, user terminal 120 includes user device (UD) 128, transceiver 124 and antenna array 126 comprising N individuals antennas 260 (shown in FIG. 2), which are selectively coupled to branches of transceiver 124. User device 128 generally includes hardware/software modules defining functionality of particular user terminal 120. For example, user devices 128 may include user controls, input/output devices (e.g., alpha-numerical keypads, keyboards, displays, speakers, microphones, printers, etc.), voice/data processing software modules, application programs, processors, memory devices, wired/optical communication devices, and the like.

In at least a portion of the base stations 110, one component antenna in antenna array 116 thereof is a re-configurable antenna, which herein is referred to as reference antenna 230_{REF} (shown in FIGS. 2 and 4-5). Reference antenna 230_{REF} may be (a) in a first state (or configuration), in which the antenna exhibits one value of electromagnetic coupling to other antennas of the array 116 (hereafter, referred to as a “CAL” state), or (b) in a second state, in which the antenna exhibits another value of the electromagnetic coupling to the other antennas of the array 116 (hereafter, referred to as a “NoCAL” state). In operation, reference antenna 230_{REF} is controllably switched between the CAL and NoCAL states, as discussed in detail below in reference to FIGS. 2-5.

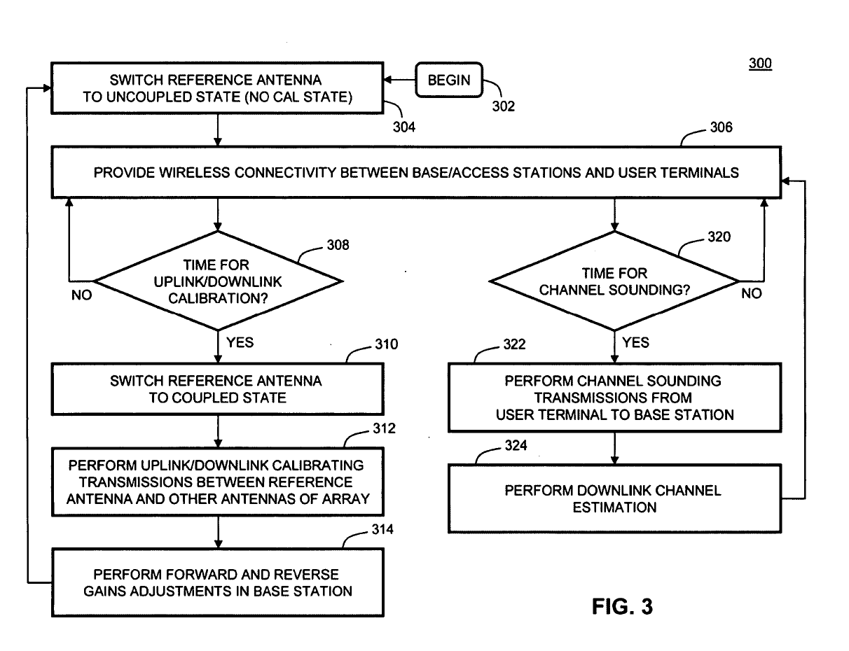

With reference now to FIGS. 2-3, therein are described illustrative embodiments of the invention. FIG. 2 illustrates a high-level block diagram of base station 110 and user terminal 120 of exemplary wireless MIMO communication system 100, in which an embodiment of the invention is implemented, and FIG. 3 is a flow chart illustrating process 300 by which methods of the illustrative embodiments are completed.

Although the features illustrated in FIGS. 2-3 may be described with reference to components shown in FIG. 1, it should be understood that this is merely for convenience and alternative components and/or configurations thereof can be employed when implementing embodiments of the invention.

Referring to FIG. 2, base station 110 of wireless MIMO communication system 100 comprises transceiver 118 and antenna array 116, and user terminal 120 includes transceiver 124, antenna array 126, and user devices 128. In operation, signals transmitted/received by antenna arrays 116 and 126 form an air (i.e., wireless) MIMO channel 202, which communicatively couples base station 110 and user terminal 120 to one another.

In base station 110, transceiver 118 generally includes data source 212, transmit (TX) data/spatial processor 214, M modulators (MODs) 216, M demodulators (DEMODs) 228, memory 218, controller 222, data sink 224, receive (RX) data/spatial processor 226, and antenna array 116, which comprises M transmit/receive antennas 230, including the reference antenna 230_{REF}. Memory 218 includes codes of programs providing operational functionality of base station 110 and components thereof and, among other software products, comprises a code of calibration program 220 containing algorithms of calibration routines performed by base station 110 in conjunction with user terminals 120.

In operation, TX data/spatial processor 214 receives traffic data from data source 212 and signaling data from controller 222. TX data processor 214 formats, codes, interleaves, and modulates the traffic data to generate modulation symbols, which are then spatially processed to provide a plurality of streams of transmit symbols for each antenna 230 of antenna array 116. Modulators 216 of antennas 230 selectively receive and process the transmit symbol stream to provide downlink modulated signals, which are then transmitted by antennas 230.

Uplink signals from user terminals 120 are selectively received via air MIMO channel 202 by antennas 230, demodulated using demodulators 228, and processed by RX data/spatial processor 226 in a substantially complementary manner to the operations performed by modulators 216 and TX data processor 214. The decoded data is provided from RX data processor 226 to data sink 224 for storage and/or to controller 222 for further processing.

Reference antenna 230_{REF} is a re-configurable antenna that may be set to the NoCAL state or to the CAL state and switched from one of these states to another. For example, the reference antenna 230_{REF} may include components switching the antenna between the NoCAL and CAL states. In the depicted embodiment, reference antenna 230_{REF} illustratively comprises a plurality of switches 232, which are operated, via interface 234, by controller 222 and define the configuration state of reference antenna 230_{REF}. In other embodiments, active electronic devices, micro-electromechanical systems (MEMS), and the like devices may be used to control the configuration of reference antenna 230_{REF}. Some such re-configurable antennas are described, for example, in U.S. Pat. Nos. 7,187,325 B2, 7,061,447 B1, and 7,068,237 B2.

In the NoCAL state, reference antenna 230_{REF} is configured to have a transmit/receive pattern adapted for providing wireless connectivity between base station 110 and user terminals 120. For example, in the NoCAL state, reference antenna 230_{REF} may have a transmit/receive pattern that provides maximum electromagnetic isolation between reference antenna 230_{REF} and other antennas 230 of antenna array 116.

In the CAL state, reference antenna 230_{REF} is configured to have a transmit/receive pattern adapted for performing calibration routines in wireless MIMO communication system 100. In one exemplary embodiment, reference antenna 230_{REF} has a transmit/receive pattern that provides high electromagnetic coupling between reference antenna 230_{REF} and other antennas 230 of antenna array 116.

In user terminal 120, transceiver 124 generally includes TX data/spatial processor 244, N modulators (MODs) 246, N demodulators (DEMODs) 258, controller 242, memory 248, receive RX data/spatial processor 256, and antenna array 126, which comprises N transmit/receive antennas 260. Memory 248 includes codes of programs providing operational functionality of user terminal 120 and components thereof. Transmit and receive paths of transceivers 118 and 124 may operate substantially complementary or similar. In operation, user device 128 performs functions of a data source/data sink of user terminal 120.

In alternate embodiments (not shown), one antenna 260 in some or all antenna arrays 126 of user terminals 120 of system 100 may be a re-configurable antenna provided with the same functionality as reference antenna 230_{REF}. In these embodiments, among other software products, memory 248 comprises code of calibration program 250 containing algorithms of calibration routines performed by user terminals 120 in conjunction with base station 110. In general, calibration programs 220 and 250 may be similar or identical.

Transceivers 118 and 124 may comprise microprocessors, application-specific integrated circuit (ASIC) devices, field-programmable arrays (FPAs), and memory arrays, among other types of IC devices. Correspondingly, memories 218 and 248 may include, but are not limited to, cache memory, random access memory (RAM), read only memory (ROM), firmware memory devices, registers, and buffers, among other storage elements.

Calibration program 220 is illustrated and described herein as a stand-alone (i.e., separate) software/firmware component, which is saved in memory module 218 and provides or supports the specific novel functions discussed below. In alternate embodiments, at least portions of calibration program 220 may be combined with other software modules incorporating functionality of their respective components.

In exemplary embodiments, calibration program 220 facilitates execution of calibration routines in the wireless MIMO communication system 100. In particular, syntax of calibration program 220 allows performing of downlink and uplink calibrating transmissions and channel sounding calibrating transmissions in the wireless MIMO communication system 100.

Among the software code/instructions provided by calibration program 220 and which are specific to the invention are: (i) code for switching reference antenna 230_{REF} to the CAL state to perform uplink/downlink calibrating transmissions between reference antenna 230_{REF} and other antennas 230 of array 116, and (ii) code for switching reference antenna 230_{REF} to the NoCAL state to perform one of (a) uplink and downlink communications and (b) calibrating channel sounding transmissions between user terminal 120 and base station 110.

For simplicity of the description, the collective body of the code that enables these various features is referred to herein as calibration program 220. According to the illustrative embodiments, when transceiver executes calibration program 220, base station 110 initiates a series of processes that enable the above functional features, as well as additional features and functionalities that are described below within the context of FIGS. 3-5.

Those of ordinary skill in the art will appreciate that hardware and software configurations depicted in FIGS. 1 and 2 may vary. For example, other hardware or software components may be used in addition to or in place of the depicted components. The wireless MIMO communication system 100 depicted in FIG. 1 may, for example, be a portion of a larger communication network, as well as may incorporate some non-MIMO or non-wireless communication devices or sub-systems. Correspondingly, implementation of functional units of transceivers 118 or 124 may be different from that depicted in FIG. 2. For example, data/spatial processors 214, 226, 244, and 256 may be realized as a separate or stand-alone data processors and spatial processors. Therefore, the architectures depicted in FIGS. 1 and 2 are basic illustrations of a wireless MIMO communication system and transceivers of base stations and user terminals thereof, for which actual implementations may vary. Thus, the depicted examples are not meant to imply architectural limitations with respect to the present invention.

Referring to FIG. 3, key portions of process 300 may be completed by calibration program 220 (executed in base station 110) and calibration program 250 (executed in user terminal 120) controlling specific operations in wireless MIMO communication system 100, therefore the process 300 is described below in the context of base station 110 and user terminal 120. To best understand the invention, the reader should refer to FIGS. 2-3 simultaneously.

The process 300 of FIG. 3 begins at block 302, at which base station 110 and user terminal 120 of MIMO communication system 100 are initiated, and proceeds to block 304. At block 304, reference antenna 230_{REF} of antenna array 116 of base station 110 is switched to the NoCAL state. At block 306, uplink and downlink communications between base station 110 and user terminal(s) 120 are performed in wireless MIMO communication system 100.

Arbitrarily, in the discussed below embodiment, process 300 proceeds from block 306 to block 308. In an alternate embodiment, process 300 may proceed from block 306 to block 320. In operation, a particular path is generally determined by timing of affirmative answers to queries of steps 308 and 320 on a “first come—first executed” basis.

Block 308 is a decision block where process 300 queries if uplink/downlink calibrating transmissions should be performed at base station 110. Such transmissions are a portion of over-the-air calibration routines in wireless MIMO communication system 100 and are performed, for example, per a pre-determined schedule or a command of controller 222. If the query is negatively answered, the process 300 proceeds back to block 306. If the query is answered affirmatively, process 300 proceeds to block 310, in which reference antenna 230_{REF} of antenna array 116 is switched to the CAL state.

At block 312, uplink and downlink calibrating transmissions (i.e., reciprocity calibrating transmissions) are performed in base station 110 between reference antenna 230_{REF} and the other antennas of antenna array 116.

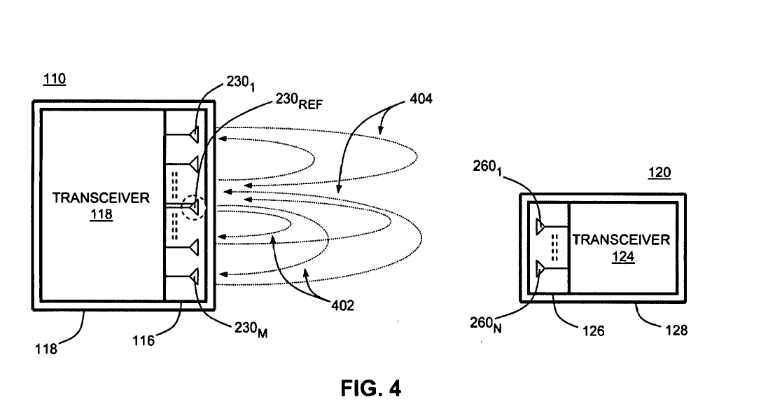

FIG. 4 is a functional block diagram illustrating the uplink and downlink calibrating transmissions. The uplink calibrating transmissions (shown with arrows 402) are performed to reference antenna 230_{REF} from all other antennas 230 of antenna array 116. Correspondingly, downlink calibrating transmissions (shown with arrows 404) are performed from reference antenna 230_{REF} to all other antennas 230 of antenna array 116. Since during these transmissions reference antenna 230_{REF} is in the CAL state (i.e., exhibits a high value of electromagnetic coupling to other antennas 230 of antenna array 116), high signal-to-noise ratios (SNRs)/low error content in the measurements may be achieved using calibrating transmissions performed at low levels of RF power.

To avoid damage of the radio frequency front-end in transceivers 118 and 124, it is understood that the degree of electromagnetic coupling can be tailored by the initial design of the reconfigurable antenna, so that a resultant power input to the antennas in the downlink or the uplink calibrating transmissions is not too excessive. Alternatively, in some systems, a resultant degree of coupling in the NoCAL state may be excessively high. In this case, since typically calibration transmitters transmit at power levels equal to those expected during a regular operation, the power provided into the transceivers could be above an acceptable limit for the safety of their front ends. It is understood that for such systems, the NoCAL state of the reference antenna will exhibit a higher degree of coupling to other antennas than the coupling exhibited in the CAL state.

At block 314, results of measurements performed during the uplink and downlink calibrating transmissions are used to determine forward and reverse gains in transceiver branches between baseband portions thereof and antennas 230 and complete gain adjustments in transceiver 118 of base station 110. Upon implementation of the gain adjustments, process 300 proceeds back to block 304, where reference antenna 230_{REF} is switched to the NoCAL state.

Block 320 is a decision block where process 300 queries if the user terminal should perform uplink channel sounding transmissions to base station 110. Such transmissions enable the BS to estimate the downlink channel response (or characteristics thereof) and are performed, for example, per a predetermined schedule or a command of controller 242. If the query is negatively answered, the process 300 proceeds back to block 306. If the query is answered affirmatively, process 300 proceeds to block 322.

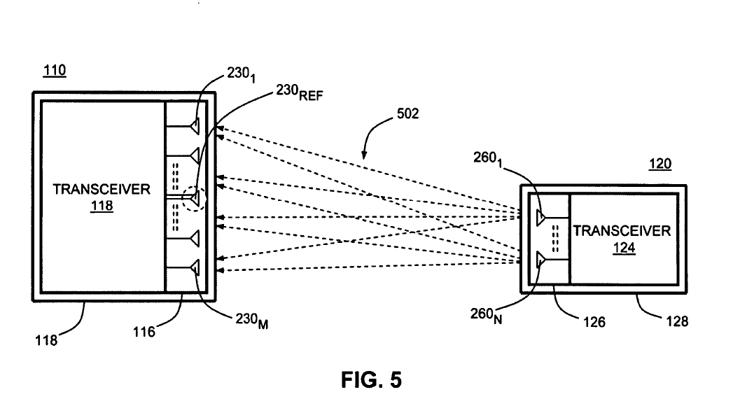

At block 322, the channel sounding transmissions are transmitted by user terminal 120 and base station 110. FIG. 5 is a functional block diagram illustrating the channel sounding transmissions (shown with arrows 502), in which user terminal 120 is a transmitting party and base station 110 is a receiving party.

At block 324, results of the channel sounding transmissions are used to perform downlink channel estimations that incorporate the corresponding adjustments in transceiver 118 at base station 100 and, alternatively or additionally, in transceiver 124 of user terminal 120. Upon implementation of the channel estimations, process 300 proceeds back to block 306.

In general, the channel sounding transmissions include transmission of either pilot symbols or data symbols, or both from user terminal 120 to base station 110. The transmission can be a specifically scheduled transmission dedicated to the purpose of enabling base station 110 to estimate the downlink channel. Alternatively, base station 110 can learn the downlink channel by leveraging ordinary uplink transmissions from user terminal 120. In either case, the downlink channel is determined by base station 110 based on the estimated uplink channel and the gain adjustments calculated in block 314.

Calculations for estimating a baseband-to-baseband downlink channel H̅_{DL} may be performed using the following equation: H̅_{DL}=c₁Ŝ· H̅_{UL}^{t}·\hat{B}, where H̅_{UL}^{t} is the transpose of a matrix describing the baseband-to-baseband uplink channel measured during the uplink channel sounding transmissions, c₁ is a constant, and \hat{B} and Ŝ are diagonal matrices whose elements are determined by the calibration transmissions at the base station 110 and user terminal 120, respectively. Each diagonal element, e.g., i-th element, is a complex number that can be expressed as the ratio of a forward to reverse baseband-to-baseband gain of the i-th transceiver. The forward gain is measured during the calibration transmissions by transmitting from the reference antenna 230_{REF} and receiving at the i-th receiver. Correspondingly, the reverse gain is measured during the calibration transmissions by transmitting from the i-th transmitter and receiving at the reference antenna 230_{REF}.

In the flow chart in FIG. 3, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Thus, it is important that while an illustrative embodiment of the present invention is described in the context of a fully functional wireless MIMO communication system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non-exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A wireless communication apparatus, comprising:
a transceiver; and
an antenna array operated by the transceiver, wherein one antenna of the array is controllably switchable between:
(i) a first state, in which the antenna exhibits a first value of electromagnetic coupling to other antennas of the array; and
(ii) a second state, in which the antenna exhibits a second value of the electromagnetic coupling to the other antennas of the array.

2. The apparatus of claim 1, wherein the antenna is a re-configurable antenna.

3. The apparatus of claim 2, wherein the antenna comprises components configured for switching the antenna between the first and second states.

4. The apparatus of claim 3, wherein the components include active electronic devices or micro-electromechanical systems (MEMS).

5. The apparatus of claim 1, wherein said apparatus is configured to perform uplink and downlink communications and calibration routines using a multiple-input multiple-output (MIMO) techniques.

6. The apparatus of claim 5, wherein the calibration routines include uplink/downlink calibrating transmissions between the antenna and the other antennas of the array.

7. The apparatus of claim 6, wherein the antenna is switched to the first state during the uplink/downlink calibrating transmissions.

8. The apparatus of claim 6, wherein the antenna is switched to the second state during one of (i) the uplink and downlink communications and (ii) the channel sounding transmissions.

9. The apparatus of claim 1, wherein the apparatus is a base or access station of a wireless communication system.

10. A wireless communication system, comprising:
one or more base stations or access stations; and
one or more user terminals, each of said stations and terminals having a transceiver and an antenna array operated by the transceiver, wherein one antenna of the array is controllably switchable between:
(i) a first state, in which the antenna exhibits a first value of electromagnetic coupling to other antennas of the array; and
(ii) a second state, in which the antenna exhibits a second value of the electromagnetic coupling to the other antennas of the array.

11. The system of claim 10, wherein the antenna is a re-configurable antenna.

12. The system of claim 11, wherein the antenna comprises components configured for switching the antenna between the first and second states.

13. The system of claim 12, wherein the components include active electronic devices or micro-electromechanical systems (MEMS).

14. The system of claim 10, wherein said system is configured to perform uplink and downlink communications and calibration routines using a multiple-input multiple-output (MIMO) techniques.

15. The system of claim 14, wherein the calibration routines include (i) uplink/downlink calibrating transmissions between the antenna and the other antennas of the array and (ii) channel sounding transmissions.

16. The system of claim 15, wherein the antenna is switched to the first state during the uplink/downlink calibrating transmissions.

17. The system of claim 15, wherein the antenna is switched to the second state during one of (i) the uplink and downlink communications and (ii) the channel sounding transmissions.

18. A method of operating a multiple-input multiple-output (MIMO) wireless communication system, comprising:
providing base or access stations and user terminals with antenna arrays, each antenna array having an antenna controllably switchable between:
(i) a first state, in which the antenna exhibits a first value of electromagnetic coupling to other antennas of the array; and
(ii) a second state, in which the antenna exhibits a second value of the electromagnetic coupling to the other antennas of the array;
switching the antenna to the first state during uplink/downlink calibrating transmissions between the antenna and the other antennas of the array; and
switching the antenna to the second state during one of (a) uplink and downlink communications and (b) channel sounding transmissions.

19. The method of claim 18, further comprising:
providing the antenna with components configured for switching the antenna between the first and second states, the components including active electronic devices or micro-electromechanical systems (MEMS).

20. The method of claim 18, further comprising:
determining forward and reverse gains of branches of a transceiver using the uplink/downlink calibrating transmissions; and
determining downlink channel estimations using the channel sounding transmissions.
